(19) United States
(12) Patent Application Publication
(10) Pub. No.: US 2026/0300636 A1
(43) Pub. Date: Oct. 1, 2026

(54) TOKENIZED MODEL TRAINING USING TERM FREQUENCY INVERSE DOCUMENT FREQUENCY

(71) Applicant: Wells Fargo Bank, N.A., San Francisco, CA (US)

(72) Inventors: Thomas Pawel Kurnicki, San Francisco, CA (US); Sudipto Saha, Charlotte, NC (US)

(21) Appl. No.: 19/097,156

(22) Filed: Apr. 1, 2025

(51) Int. Cl. G06F 40/35; G06F 40/284; H04L 51/21

(52) U.S. Cl. CPC G06F 40/35; G06F 40/284; H04L 51/21

(57) ABSTRACT

Systems and techniques may generally be used for predicting customer complaints in electronic communications. An example technique may include receiving a plurality of electronic mail messages, preprocessing the plurality of electronic mail messages to create structured text data of each message of the plurality of electronic mail messages, and tokenizing the structured text data of each message to generate a set of tokens corresponding to each word in the structured text data of each message. The example technique may include determining a term frequency within each message of respective tokens, determining an inverse document frequency in the structured text data of each token, generating a uniqueness score for each token based on the term frequency and the inverse document frequency, and training a machine learning model to predict whether an electronic mail message includes a customer complaint using the uniqueness score.

### BACKGROUND

Traditional approaches for identifying customer complaints in electronic communications rely primarily on sentiment analysis and basic term count analysis. These conventional methods often have limitations in accurately identifying complaints that may not contain obvious negative sentiment patterns. Current systems often lack the ability to detect nuanced complaints where the emotional tone may not clearly indicate dissatisfaction.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a block diagram for training or using a machine learning model to identify complaints in electronic messages in accordance with some examples.

FIG. 2 illustrates a block diagram showing data flow for using term frequency inverse document frequency to train or use a model to identify that an electronic message includes a complaint in accordance with some examples.

FIG. 3 illustrates a machine learning engine for training and execution related to in accordance with some examples.

FIG. 4 illustrates a flowchart showing a technique for predicting customer complaints in electronic communications in accordance with some examples.

FIG. 5 illustrates generally an example of a block diagram of a machine upon which any one or more of the techniques discussed herein may perform in accordance with some examples.

### DETAILED DESCRIPTION

The systems and techniques described herein may be used to train or use a machine learning model for predicting customer complaints from email or other electronic communications using uniqueness features. In an example, Term Frequency-Inverse Document Frequency (TF-IDF) is used on an email corpus. TF-IDF is a statistical technique used in natural language processing that is used to determine importance of a word or text string within a document and among a larger collection or corpus of documents. TF-IDF evaluates a uniqueness of a word by balancing reliance on frequency of a word in a specific document and how common or rare that word is across the entire corpus. Using TF-IDF helps identify key terms that characterize a given document while filtering out commonly used words that may not carry unique significance. By calculating a TF-IDF score for each token, distinctive word patterns may be detected that indicate complaints, regardless of sentiment. A score may be used as input for training a model, such as a gradient boosting model. The model, once trained, may be used to identify complaints with a reduction in false positives and negatives while ensuring that genuine complaints are identified and addressed promptly, enhancing customer service and compliance.

A TF-IDF score may be calculated by generating a TF and an IDF score. The TF score may be generated for a word based on a number of times the word appears in a single text document (e.g., digital communication) divided by a total number of words in the single text document. The number of times the word appears may be generated after standardizing the text (e.g., “improve”, “improving”, and “improved” may all be shortened to “improve” and considered the same word for purposes of the TF score). The IDF score may be generated by comparing how many times the word appears across all documents (or a subset of documents) in a corpus (e.g., a set of documents). For example, the IDF may be equal to a log function of the number of documents in the corpus divided by the number of documents including the word. The TF-IDF score may be generated based on a combination of the TF and the IDF scores (e.g., by multiplying them together, by a weighted multiplication, etc.). For example, a TF-IDF score may be generated according to Equation 1 below, where X is the number of times a word appears in a document, W is the total number of words in the document, Nall is the total number of documents in a corpus, and Nx is the number of documents in the corpus where the word appears. The score generated by Equation 1 is specific to a word-document combination. That is, the score gives an indication of uniqueness of the word within the document and corpus. A high score indicates that the term is frequent in the document and not frequent in the corpus, while a low score indicates that the word is either common in the corpus, is not frequent in the document, or both.

$$Score = \frac{X}{W} * log ( \frac{Nall}{Nx} ) \qquad Equation 1$$

According to Equation 1, an example may include if the term “refund” appears 3 times in a 100-word email, and appears in 50 emails out of 20,000 total emails, the TF=3/100=0.03, the IDF=log(20000/50)=2.60, the TF-IDF=0.03*2.60=0.078. The scores may be used as a feature input for a machine learning model to predict likelihood of a complaint in a document, as described further below.

Traditional models for predicting customer complaints from emails often rely on sentiment analysis, which can lead to high rates of false positives and false negatives. These models struggle to accurately identify complaints, especially when the language used does not convey obvious negative sentiment. This inefficiency can result in delayed responses to genuine complaints, impacting customer satisfaction and compliance obligations. Additionally, the large volume of emails received by the wealth investment management division makes it challenging to manually review and address complaints in a timely manner.

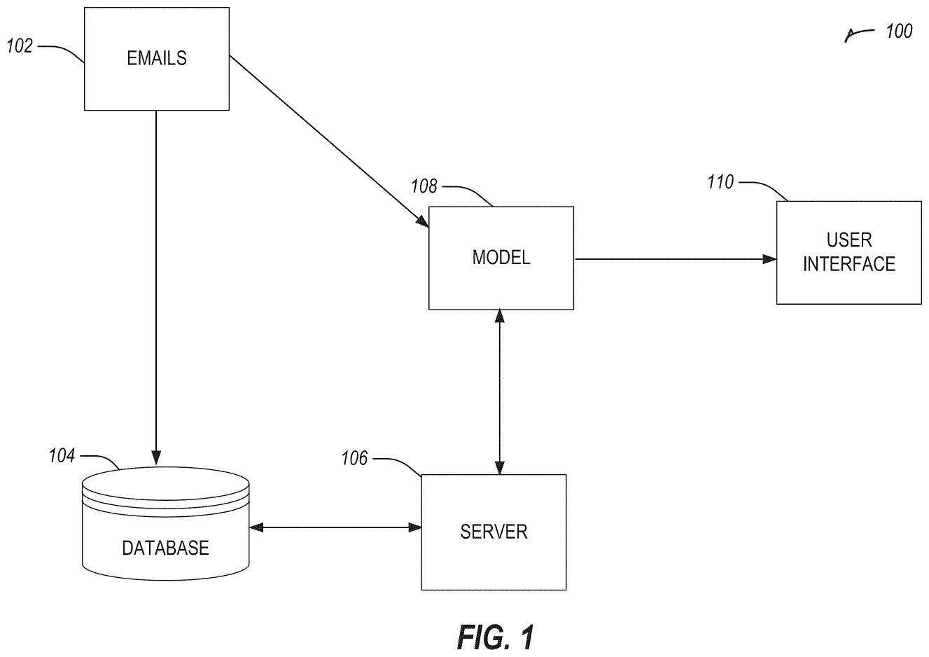

FIG. 1 illustrates a block diagram 100 for training or using a machine learning model to identify complaints in electronic messages in accordance with some examples. The block diagram 100 includes a set of inbound emails 102, which may be stored in a database 104. A server 106 may access the database 104 to retrieve the emails. Text from the emails may be processed at the server 106 to generate a TF-IDF score for tokens in the text. TF-IDF scores for tokens may be used to train a model 108 to predict whether an email includes a customer complaint, for example. The model 108, once trained, may output, for example to a user interface 110, an indication of whether an email is predicted to include a complaint. The model 108 may output a set of emails that include predicted complaints to the user interface 110. The user interface 110 may display an email or set of emails predicted to include a customer complaint.

The model 108 may be retrained (e.g., from a base model, from a previously trained model using uniqueness scores, etc.) using further emails from the set of emails 102 (e.g., emails that flow into an enterprise daily). The uniqueness scores may be used to reduce false positives and false negatives in predictions by the model 108. For example, a typical LLM or a model trained without using TF-IDF may not be domain focused enough to determine when an email is routine for a particular purpose or when it includes classifiable subject matter (e.g., a complaint or a complaint requiring redress, such as a quick response), resulting in false positives. In an example, models trained using sentiment analysis may miss a calmly or professionally worded complaint, resulting in a false negative.

The server 106 may retrieve the emails 102 from the database 104 and perform a preprocessing operation, for example to remove non-business content, spam content, echo content, signature content, automated response content, reply chains, names, phone numbers, social security numbers, references to money, times, email addresses, URLs, dates, and numbers, etc. The preprocessed text may be structured and then tokenized. Structuring the preprocessed text or preprocessing may include standardizing acronyms, removing punctuation, accounting for differences in spacing (e.g., single versus double), removing white spaces, removing non-standard characters, punctuations, acronyms, non-ASCII characters, HTML tags and entities, excessive white spaces, or converting upper case letters to lower case, etc. The standardized text may then be tokenized. The server 106, by using this technique, causes each email body to become a combination of tokens.

The server 106 may take the combination of tokens for each email and calculate a TF-IDF score for each token. The score may be used to train the model 108. The model 108 may be trained by applying a gradient boosting model. After the model 108 is trained, the model 108 may be used to predict for new emails whether there is a complaint. This inferencing may include preprocessing an email, standardizing text of the email, tokenizing the standardized text, and generating a TF-IDF score for tokens (e.g., where the IDF is compared to a set of emails stored in the database 104, such as the initial training set, an augmented training set, a set of emails for a day or week or other time period, or the like). The score may be used to predict whether there is a complaint in the email.

Other digital communications may include a chat message, a social media post, a blog post, etc. In an example, for a chat message, chat-specific formatting or metadata may be removed. A chat conversation may be standardized into a set of text segments or considered as an entire message. Uniqueness features may be generated (e.g., using TF-IDF) accounting for informal language patterns or chat abbreviations. For social media posts, platform-specific content like hashtags, mentions, and emojis may be removed or given a score. A social media post or set of posts may be standardized into a set of text segments or considered as a coherent communication.

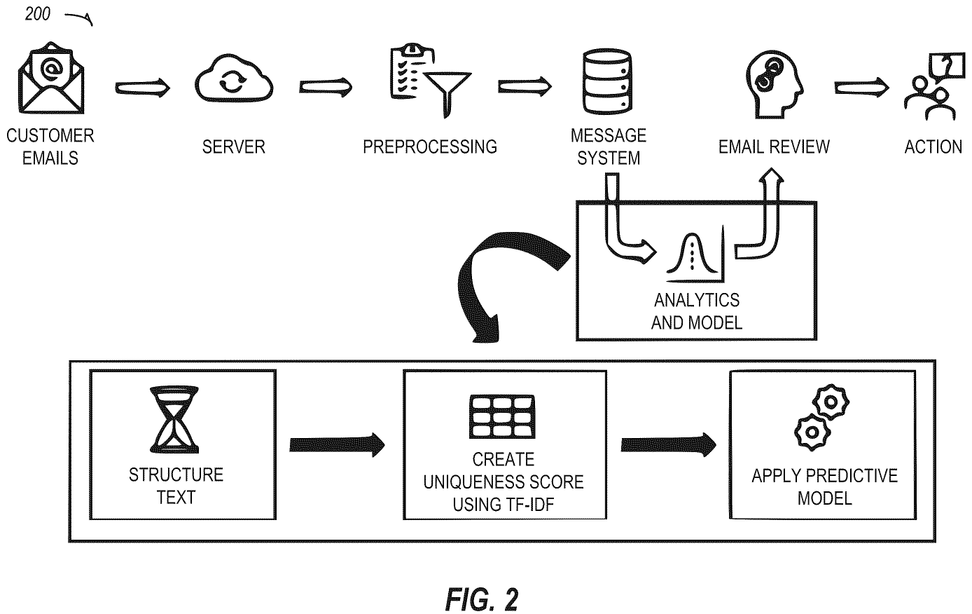

FIG. 2 illustrates a block diagram 200 showing data flow for using term frequency inverse document frequency to train or use a model to identify that an electronic message includes a complaint in accordance with some examples. The block diagram 200 illustrates text flow as an email is received, for predicting whether the email includes a customer complaint. The block diagram 200 includes collecting customer emails. The emails are typically received through a server, which manages the flow of emails and ensures secure storage.

From the server, the emails may undergo preprocessing. The preprocessing may be used to clean up and structure unstructured text data in the emails. Preprocessing may include removing spam, echoes, signatures, non-business content, punctuations, acronyms, or non-ASCII characters. The preprocessed text is then tokenized, grouping similar words or word stems under single tokens to prepare the data for further analysis. When processing email chains that span multiple days or months, the temporal relationship of the communications may be maintained while removing duplicative content. For chains occurring over a short period of time (e.g., within a day, over 1-2 days, etc.), preprocessing may consolidate the content into a single document for processing, for example after removing forwarded content or reply artifacts. Preprocessing may account for variations in how terms are written, such as different forms of acronyms or company names (e.g., an acronym, a shortened form of a company name, and a full company name may all be considered the same word). The variations may be normalized through a masking process that ensures consistent token representation. Preprocessing may apply filtering to isolate the business-relevant portions, for example by removing non-relevant words or items, such as signatures, spam content, emojis, etc.

After the emails are preprocessed, the emails may be stored in a message system, which acts as a central repository for the structured text data. The message system may be designed to handle large volumes of data efficiently. The text may be retrieved for analytics and modeling. Analytics and modeling may include structuring text, creating a uniqueness score, and applying the uniqueness score for use in a predictive model (e.g., to train the model or for inferencing an email). The structured text data may undergo analysis to identify potential customer complaints, for example by calculating a TF-IDF score for each token of an email. The TF-IDF score may be used as an input for a machine learning model, such as a Gradient Boosting Model, to generate predictions indicating the likelihood of customer complaints. In some examples, the model may be trained based on labels related to whether an email includes a customer complaint. The labels may be specific to a particular business unit or field.

When an email is predicted to include a customer complaint by the model, a review may occur. The review may include performing a sentiment analysis on the email, such as by using an LLM, running a script, etc. The review may be initiated by sending an alert to a user device indicating the email potentially includes a complaint. The review may occur by displaying the email on the user device for a human to review. The review may result in identifying an action to perform, such as a remedy for a complaint. The remedy may include sending an automated email response (which may optionally be customized to the complaint or the complainant before sending, such as from a script email), escalating the complaint to a human (e.g., a first review human or a supervisor), taking an automated action (e.g., refunding an amount, placing a hold on an account, etc.), updating a customer record, or the like.

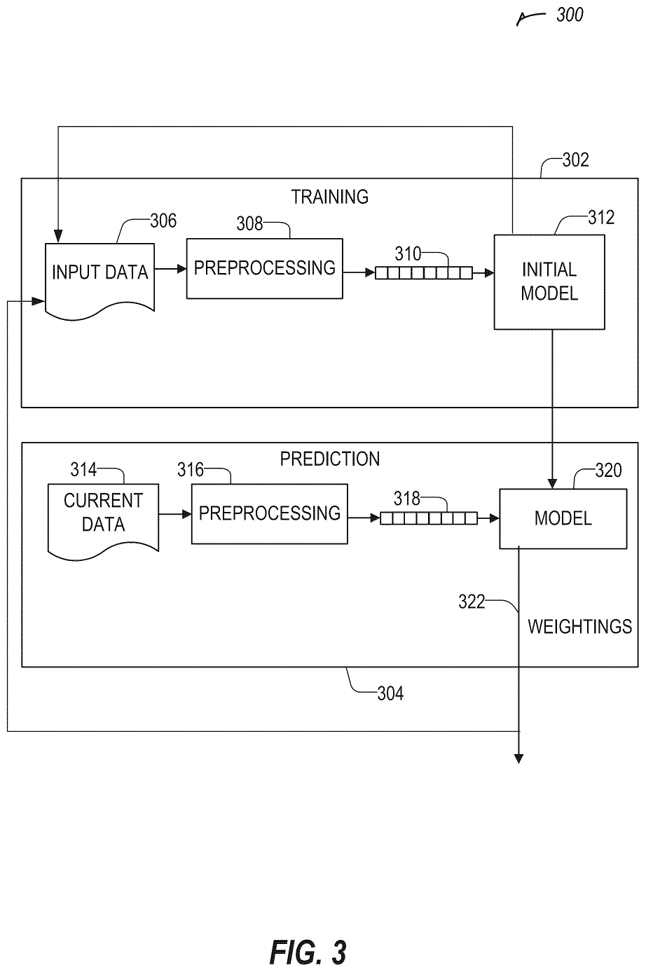

FIG. 3 illustrates a machine learning engine for training and execution related to determining an attack surface for a malicious attack on an application in accordance with some examples. The machine learning engine may be deployed to execute at a mobile device (e.g., a cell phone, a tablet, etc.) or a computer (e.g., a desktop, a laptop, etc.). FIG. 3 shows an example machine learning engine 300 according to some examples of the present disclosure. Example model types of the machine learning engine 300 may include Random Forest, AdaBoost, XGBoost, LightGBM, CatBoost, Gradient Boosting, Histogram-Based Gradient Boosting, or the like.

Machine learning engine 300 uses a training engine 302 and a prediction engine 304. Training engine 302 uses input data 306, for example after undergoing preprocessing component 308, to determine one or more features 310. The one or more features 310 may be used to generate an initial model 312, which may be updated iteratively or with future labeled or unlabeled data (e.g., during reinforcement learning), for example to improve the performance of the prediction engine 304 or the initial model 312. An improved model may be redeployed for use.

The input data 306 may include a uniqueness score of a token. The uniqueness score may be generated using a TF-IDF technique as described herein. The token may be generated by tokenizing structured text data (e.g., generated from preprocessing electronic mail messages).

In the prediction engine 304, current data 314 (e.g., an electronic mail message) may be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction engine 304 may be designed to operate in an online manner (e.g., in real-time, at a mobile device, on a wearable device, etc.). In some examples, the model 320 may be periodically updated via additional training (e.g., via updated input data 306 or based on labeled or unlabeled data output in the weightings 322) or based on identified future data, such as by using reinforcement learning to personalize a general model (e.g., the initial model 312) to a particular user.

Labels for the input data 306 may include whether an electronic mail message included a customer complaint, a severity level of a customer complaint, a difficulty level of responding to a complaint, etc.

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, information bottleneck method, and Latent Dirichlet Allocation (LDA). Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), logistic regression, gradient boosting, xgboosting, random forest, AdaBoost, LightGBM, CatBoost, or the like.

Once trained, the model 320 may output a prediction, such as whether an electronic mail message includes a customer complaint. Another example prediction may include a risk level of an electronic mail message (e.g., a risk level corresponding to whether the electronic mail message is a customer complaint, a risk level corresponding to a difficulty in responding to the electronic mail message, a risk level corresponding to a severity of a complaint in the electronic mail message, or the like).

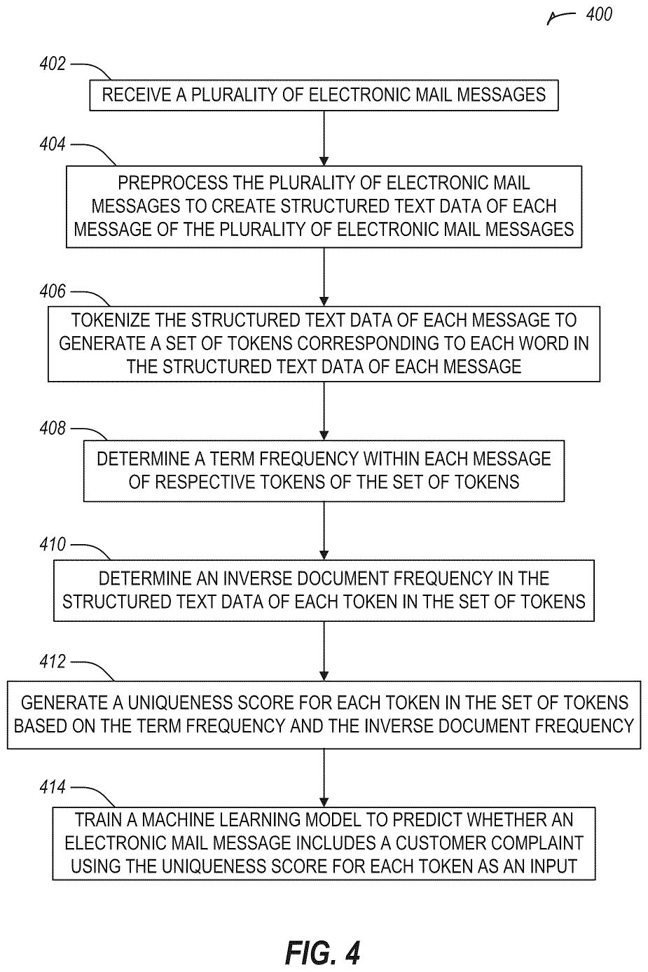

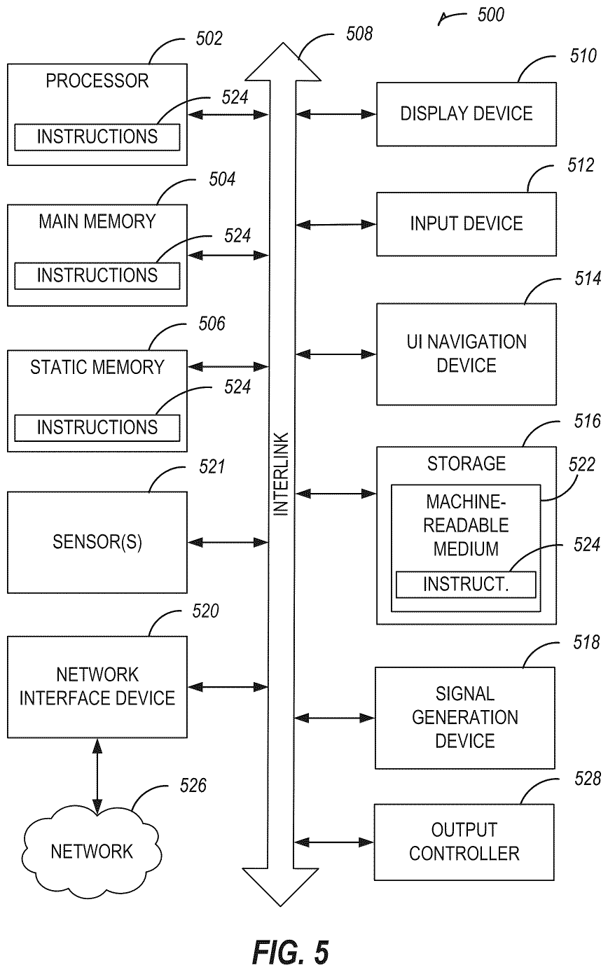

FIG. 4 illustrates a flowchart showing a technique for predicting customer complaints in electronic communications in accordance with some examples. In an example, operations of the technique 400 may be performed by processing circuitry, for example by executing instructions stored in memory. The processing circuitry may include a processor, a system on a chip, or other circuitry (e.g., wiring). For example, technique 400 may be performed by processing circuitry of a device (or one or more hardware or software components thereof), such as those illustrated and described with reference to FIG. 5.

The technique 400 includes an operation 402 to receive a plurality of electronic mail messages. The plurality of electronic mail messages may include tens of thousands, hundreds of thousands, or millions of emails.

The technique 400 includes an operation 404 to preprocess the plurality of electronic mail messages to create structured text data of each message of the plurality of electronic mail messages. Operation 404 may include removing non-business content, spam content, echo content, signature content, automated response content, reply chains, names, phone numbers, social security numbers, references to money, times, email addresses, URLs, dates, numbers, or the like. Operation 404 may include removing punctuations, acronyms, non-ASCII characters, HTML tags and entities, excessive white spaces, or the like. Operation 404 may include converting upper case letters to lower case.

The technique 400 includes an operation 406 to tokenize the structured text data of each message to generate a set of tokens corresponding to each word in the structured text data of each message. Operation 406 may include grouping semantically equivalent words under common tokens, and normalizing variations of acronyms and company names through a masking process.

The technique 400 includes an operation 408 to determine a term frequency within each message of respective tokens of the set of tokens. In an example, the term frequency is generated by dividing a number of times a word or token appears in a single electronic mail message by a total number of words in the single electronic mail message.

The technique 400 includes an operation 410 to determine an inverse document frequency in the structured text data of each token in the set of tokens. In an example, the inverse document frequency is generated by taking a log function of a number of messages in the plurality of electronic mail messages divided by a number of messages within the plurality of electronic mail messages that include the word or token.

The technique 400 includes an operation 412 to generate a uniqueness score for each token in the set of tokens based on the term frequency and the inverse document frequency. The uniqueness score multiplying the term frequency and the inverse document frequency to generate a term frequency inverse document frequency (TF-IDF) score for each token. For example, the uniqueness score may be generated using Equation 1.

The technique 400 includes an operation 414 to train a machine learning model to predict whether an electronic mail message includes a customer complaint using the uniqueness score for each token as an input. The machine learning model may include a gradient boosting model. Training the gradient boosting model may include tuning hyperparameters of the gradient boosting model using grid search optimization to improve prediction accuracy. The technique 400 may include generating, using the machine learning model, a prediction identifying that an electronic mail message in a second plurality of electronic mail messages includes a customer complaint. In some examples, the machine learning model may be retrained (e.g., based on further received electronic mail messages). The machine learning model may be used to generate a prediction identifying a risk level of an electronic mail message in a second plurality of electronic mail messages.

FIG. 5 illustrates generally an example of a block diagram of a machine upon which any one or more of the techniques discussed herein may perform, according to various examples. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500, and includes digital or analog communications signals or other intangible medium to facilitate communication of such software.

The following, non-limiting examples, detail certain aspects of the present subject matter to solve the challenges and provide the benefits discussed herein, among others.

Example 1 is a method for predicting customer complaints in electronic communications, comprising: receiving a plurality of electronic mail messages; preprocessing the plurality of electronic mail messages to create structured text data of each message of the plurality of electronic mail messages; tokenizing the structured text data of each message to generate a set of tokens corresponding to each word in the structured text data of each message; determining a term frequency within each message of respective tokens of the set of tokens; determining an inverse document frequency in the structured text data of each token in the set of tokens; generating a uniqueness score for each token in the set of tokens based on the term frequency and the inverse document frequency; and training a machine learning model to predict whether an electronic mail message includes, a customer complaint using the uniqueness score for each token as an input.

In Example 2, the subject matter of Example 1 includes, wherein preprocessing the plurality of electronic mail messages comprises, removing: non-business content, spam content, echo content, signature content, automated response content, reply chains, names, phone numbers, social security numbers, references to money, times, email addresses, URLs, dates, and numbers.

In Example 3, the subject matter of Examples 1-2 includes, wherein preprocessing the plurality of electronic mail messages comprises, removing: punctuations, acronyms, non-ASCII characters, HTML tags and entities, and excessive white spaces; and converting upper case letters to lower case.

In Example 4, the subject matter of Examples 1-3 includes, wherein tokenizing the structured text data comprises: grouping semantically equivalent words under common tokens; and normalizing variations of acronyms and company names through a masking process.

In Example 5, the subject matter of Examples 1-4 includes, wherein generating the uniqueness score comprises multiplying the term frequency and the inverse document frequency to generate a term frequency inverse document frequency (TF-IDF) score for each token.

In Example 6, the subject matter of Examples 1-5 includes, wherein the machine learning model comprises a gradient boosting model.

In Example 7, the subject matter of Example 6 includes, tuning hyperparameters of the gradient boosting model using grid search optimization to improve prediction accuracy.

In Example 8, the subject matter of Examples 1-7 includes, generating, using the machine learning model, a prediction identifying that an electronic mail message in a second plurality of electronic mail messages includes a customer complaint.

In Example 9, the subject matter of Examples 1-8 includes, generating, using the machine learning model, a prediction identifying a risk level of an electronic mail message in a second plurality of electronic mail messages.

Example 10 is a system for predicting customer complaints in electronic communications, comprising: one or more hardware processors; and at least one memory storing instructions that, when executed by the one or more hardware processors, cause the system to perform operations comprising: receiving a plurality of electronic mail messages; preprocessing the plurality of electronic mail messages to create structured text data of each message of the plurality of electronic mail messages; tokenizing the structured text data of each message to generate a set of tokens corresponding to each word in the structured text data of each message; determining a term frequency within each message of respective tokens of the set of tokens; determining an inverse document frequency in the structured text data of each token in the set of tokens; generating a uniqueness score for each token in the set of tokens based on the term frequency and the inverse document frequency; and training a machine learning model to predict whether an electronic mail message includes, a customer complaint using the uniqueness score for each token as an input.

In Example 11, the subject matter of Example 10 includes, wherein preprocessing the plurality of electronic mail messages comprises, removing: non-business content, spam content, echo content, signature content, automated response content, reply chains, names, phone numbers, social security numbers, references to money, times, email addresses, URLs, dates, and numbers.

In Example 12, the subject matter of Examples 10-11 includes, wherein preprocessing the plurality of electronic mail messages comprises, removing: punctuations, acronyms, non-ASCII characters, HTML tags and entities, and excessive white spaces; and converting upper case letters to lower case.

In Example 13, the subject matter of Examples 10-12 includes, wherein tokenizing the structured text data comprises: grouping semantically equivalent words under common tokens; and normalizing variations of acronyms and company names through a masking process.

In Example 14, the subject matter of Examples 10-13 includes, wherein generating the uniqueness score comprises multiplying the term frequency and the inverse document frequency to generate a term frequency inverse document frequency (TF-IDF) score for each token.

In Example 15, the subject matter of Examples 10-14 includes, wherein the machine learning model comprises a gradient boosting model.

In Example 16, the subject matter of Example 15 includes, operations including tuning hyperparameters of the gradient boosting model using grid search optimization to improve prediction accuracy.

In Example 17, the subject matter of Examples 10-16 includes, operations including generating, using the machine learning model, a prediction identifying that an electronic mail message in a second plurality of electronic mail messages includes a customer complaint.

In Example 18, the subject matter of Examples 10-17 includes, operations including generating, using the machine learning model, a prediction identifying a risk level of an electronic mail message in a second plurality of electronic mail messages.

Example 19 is at least one non-transitory machine readable medium including instructions for predicting customer complaints in electronic communications, which when executed by processing circuitry, cause the processing circuitry to perform operations comprising: receiving a plurality of electronic mail messages; preprocessing the plurality of electronic mail messages to create structured text data of each message of the plurality of electronic mail messages; tokenizing the structured text data of each message to generate a set of tokens corresponding to each word in the structured text data of each message; determining a term frequency within each message of respective tokens of the set of tokens; determining an inverse document frequency in the structured text data of each token in the set of tokens; generating a uniqueness score for each token in the set of tokens based on the term frequency and the inverse document frequency; and training a machine learning model to predict whether an electronic mail message includes, a customer complaint using the uniqueness score for each token as an input.

In Example 20, the subject matter of Example 19 includes, wherein preprocessing the plurality of electronic mail messages comprises, removing: non-business content, spam content, echo content, signature content, automated response content, reply chains, names, phone numbers, social security numbers, references to money, times, email addresses, URLs, dates, and numbers.

Example 21 is a system for predicting customer complaints in electronic communications, comprising: one or more hardware processors; and at least one memory storing instructions that, when executed by the one or more hardware processors, cause the system to perform operations comprising: receiving a plurality of digital messages; preprocessing the plurality of digital messages to create structured text data of each message of the plurality of digital messages; tokenizing the structured text data of each message to generate a set of tokens corresponding to each word in the structured text data of each message; determining a term frequency within each message of respective tokens of the set of tokens; determining an inverse document frequency in the structured text data of each token in the set of tokens; generating a uniqueness score for each token in the set of tokens based on the term frequency and the inverse document frequency; and training a machine learning model to predict whether a digital message includes, a customer complaint using the uniqueness score for each token as an input.

In Example 22, the subject matter of Example 21 includes, wherein the plurality of digital messages are chat messages, and wherein preprocessing the plurality of digital messages comprises: removing chat-specific formatting and metadata; structuring real-time conversation flows into text segments; calculating uniqueness features based on chat abbreviations and informal language patterns; and adapting machine learning model parameters for chat message length.

In Example 23, the subject matter of Examples 21-22 includes, wherein the plurality of digital messages are social media posts, and wherein preprocessing the plurality of digital messages comprises: processing platform-specific content including hashtags, mentions, and emojis; structuring posts and comment threads into coherent text units; calculating uniqueness features based on social media vocabulary; and adjusting machine learning parameters for public communication patterns.

Example 24 is at least one machine-readable medium including instructions that, when executed by processing circuitry, cause the processing circuitry to perform operations to implement of any of Examples 1-23.

Example 25 is an apparatus comprising means to implement of any of Examples 1-23.

Example 26 is a system to implement of any of Examples 1-23.

Example 27 is a method to implement of any of Examples 1-23.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for predicting customer complaints in electronic communications, comprising:
receiving a plurality of electronic mail messages;
preprocessing the plurality of electronic mail messages to create structured text data of each message of the plurality of electronic mail messages;
tokenizing the structured text data of each message to generate a set of tokens corresponding to each word in the structured text data of each message;
determining a term frequency within each message of respective tokens of the set of tokens;
determining an inverse document frequency in the structured text data of each token in the set of tokens;
generating a uniqueness score for each token in the set of tokens based on the term frequency and the inverse document frequency; and
training a machine learning model to predict whether an electronic mail message includes a customer complaint using the uniqueness score for each token as an input.

2. The method of claim 1, wherein preprocessing the plurality of electronic mail messages comprises, removing:
non-business content, spam content, echo content, signature content, automated response content, reply chains, names, phone numbers, social security numbers, references to money, times, email addresses, URLs, dates, and numbers.

3. The method of claim 1, wherein preprocessing the plurality of electronic mail messages comprises, removing:
punctuations, acronyms, non-ASCII characters, HTML tags and entities, and excessive white spaces; and
converting upper case letters to lower case.

4. The method of claim 1, wherein tokenizing the structured text data comprises:
grouping semantically equivalent words under common tokens; and
normalizing variations of acronyms and company names through a masking process.

5. The method of claim 1, wherein generating the uniqueness score comprises multiplying the term frequency and the inverse document frequency to generate a term frequency inverse document frequency (TF-IDF) score for each token.

6. The method of claim 1, wherein the machine learning model comprises a gradient boosting model.

7. The method of claim 6, further comprising tuning hyperparameters of the gradient boosting model using grid search optimization to improve prediction accuracy.

8. The method of claim 1, further comprising generating, using the machine learning model, a prediction identifying that an electronic mail message in a second plurality of electronic mail messages includes a customer complaint.

9. The method of claim 1, further comprising generating, using the machine learning model, a prediction identifying a risk level of an electronic mail message in a second plurality of electronic mail messages.

10. A system for predicting customer complaints in electronic communications, comprising:
one or more hardware processors; and
at least one memory storing instructions that, when executed by the one or more hardware processors, cause the system to perform operations comprising:
receiving a plurality of electronic mail messages;
preprocessing the plurality of electronic mail messages to create structured text data of each message of the plurality of electronic mail messages;
tokenizing the structured text data of each message to generate a set of tokens corresponding to each word in the structured text data of each message;
determining a term frequency within each message of respective tokens of the set of tokens;
determining an inverse document frequency in the structured text data of each token in the set of tokens;
generating a uniqueness score for each token in the set of tokens based on the term frequency and the inverse document frequency; and
training a machine learning model to predict whether an electronic mail message includes a customer complaint using the uniqueness score for each token as an input.

11. The system of claim 10, wherein preprocessing the plurality of electronic mail messages comprises, removing:
non-business content, spam content, echo content, signature content, automated response content, reply chains, names, phone numbers, social security numbers, references to money, times, email addresses, URLs, dates, and numbers.

12. The system of claim 10, wherein preprocessing the plurality of electronic mail messages comprises, removing:
punctuations, acronyms, non-ASCII characters, HTML tags and entities, and excessive white spaces; and
converting upper case letters to lower case.

13. The system of claim 10, wherein tokenizing the structured text data comprises:
grouping semantically equivalent words under common tokens; and
normalizing variations of acronyms and company names through a masking process.

14. The system of claim 10, wherein generating the uniqueness score comprises multiplying the term frequency and the inverse document frequency to generate a term frequency inverse document frequency (TF-IDF) score for each token.

15. The system of claim 10, wherein the machine learning model comprises a gradient boosting model.

16. The system of claim 15, further comprising operations including tuning hyperparameters of the gradient boosting model using grid search optimization to improve prediction accuracy.

17. The system of claim 10, further comprising operations including generating, using the machine learning model, a prediction identifying that an electronic mail message in a second plurality of electronic mail messages includes a customer complaint.

18. The system of claim 10, further comprising operations including generating, using the machine learning model, a prediction identifying a risk level of an electronic mail message in a second plurality of electronic mail messages.

19. At least one non-transitory machine readable medium including instructions for predicting customer complaints in electronic communications, which when executed by processing circuitry, cause the processing circuitry to perform operations comprising:
receiving a plurality of electronic mail messages;
preprocessing the plurality of electronic mail messages to create structured text data of each message of the plurality of electronic mail messages;
tokenizing the structured text data of each message to generate a set of tokens corresponding to each word in the structured text data of each message;
determining a term frequency within each message of respective tokens of the set of tokens;
determining an inverse document frequency in the structured text data of each token in the set of tokens;
generating a uniqueness score for each token in the set of tokens based on the term frequency and the inverse document frequency; and
training a machine learning model to predict whether an electronic mail message includes a customer complaint using the uniqueness score for each token as an input.

20. The at least one non-transitory machine readable medium of claim 19, wherein preprocessing the plurality of electronic mail messages comprises, removing:
non-business content, spam content, echo content, signature content, automated response content, reply chains, names, phone numbers, social security numbers, references to money, times, email addresses, URLs, dates, and numbers.
